(19) United States
(12) Patent Application Publication
(10) Pub. No.: US 2018/0219252 A1
(43) Pub. Date: Aug. 2, 2018

(54) NONAQUEOUS ELECTROLYTE SECONDARY BATTERY, ELECTRIC STORAGE DEVICE, MANUFACTURING METHOD THEREFOR, AND ELECTRIC STORAGE CIRCUIT

(71) Applicant: Murata Manufacturing Co., Ltd., Nagaokakyo-shi (JP)

(72) Inventor: Masaharu ltaya, Nagaokakyo-shi (JP)

(21) Appl. No.: 15/936,899

(22) Filed: Mar. 27, 2018

Related U.S. Application Data
(63) Continuation of application No. PCT/JP2016/078447, filed on Sep. 27, 2016.

(30) Foreign Application Priority Data
Sep. 29, 2015 (JP) 2015-191681

(51) Int. Cl. H01M 10/0525; H01M 10/058; H01M 10/0569; H01M 10/0568; H01M 10/42; H01M 4/134; H01M 4/66; H01M 2/16; H01G 11/62; H01G 11/60; H01G 11/08

(52) U.S. Cl. CPC H01M 10/0525; H01M 10/058; H01M 10/0569; H01M 10/0568; H01M 10/425; H01M 2004/027; H01M 4/661; H01M 2/1626; H01G 11/62; H01G 11/60; H01G 11/08; H01M 4/134

(57) ABSTRACT

A nonaqueous electrolyte secondary battery that includes a positive electrode; a negative electrode; a separator interposed between the positive electrode and the negative electrode; a nonaqueous electrolytic solution, an exterior body that houses the electrodes, the separator, and the solution a positive electrode terminal electrically connected to the positive electrode and extended outside the exterior body; and a negative electrode terminal electrically connected to the negative electrode and extended outside the exterior body. The nonaqueous electrolytic solution contains an imide salt of perfluoroalkanesulfonic acid; the negative electrode contains a noble negative electrode active material that has a lithium occlusion/release potential of 1.0 V (vs Li/Li⁺) or higher, and the battery voltage is 0 V to 1.0 V.

### CROSS REFERENCE TO RELATED APPLICATIONS

The present application is a continuation of International application No. PCT/JP2016/078447, filed Sep. 27, 2016, which claims priority to Japanese Patent Application No. 2015-191681, filed Sep. 29, 2015, the entire contents of each of which are incorporated herein by reference.

### FIELD OF THE INVENTION

The present invention relates to a secondary battery, and more particularly to a nonaqueous electrolyte secondary battery including a positive electrode, a negative electrode, a separator, and a nonaqueous electrolytic solution, an electric storage device that uses the battery, a manufacturing method therefor, and an electric storage circuit.

### BACKGROUND OF THE INVENTION

In recent years, the reduction in size and weight for cellular phones, laptop computers, and the like has been progressed rapidly, and batteries as power sources for driving the phones, the computers, and the like have been required to have higher capacities. Under such circumstances, nonaqueous electrolyte secondary batteries typified by lithium ion secondary batteries are widely used as power sources.

Now, as a nonaqueous electrolyte secondary battery as described above, for example, Patent Document 1 proposes a nonaqueous electrolyte secondary battery including a positive electrode, a negative electrode, a nonaqueous electrolytic solution, and a separator, where the nonaqueous electrolyte contains an ionic liquid, the negative electrode contains a noble negative electrode active material that has a lithium occlusion/release potential of 1.0 V (vs Li/Li⁺) or higher and substantially contains no conductivity aid, and the separator contains at least one selected from the group consisting of polyethylene terephthalate, cellulose, polyamideimide, polyimide, and an inorganic filler.

Further, the nonaqueous electrolyte secondary battery is supposed to make it possible to improve the heat resistance of the nonaqueous electrolyte secondary battery under an environment at a high temperature in excess of 60° C., and thus provide a nonaqueous electrolyte secondary battery which can be surface-mounted onto a substrate by reflow-type soldering.

However, in recent years, as nonaqueous electrolyte secondary batteries have been expanding in application, the temperature conditions in use and the temperature conditions during the process of mounting onto substrates have been increasing, and for example, in the process of mounting onto substrates, reflow soldering has been increasingly performed under high-temperature conditions such as 260° C. Therefore, nonaqueous electrolyte secondary batteries have been desired which are excellent in resistance to these higher temperatures.

Patent Document 1: Japanese Patent No. 5447517

### SUMMARY OF THE INVENTION

The present invention is intended to solve the problem mentioned above, and an object of the invention is to provide a nonaqueous electrolyte secondary battery which is excellent in resistance to high temperature, an electric storage device that uses the battery, a manufacturing method therefor, and a highly reliable electric storage circuit, which can be used in such a case where mounting onto a substrate is performed by reflow-type soldering at a higher temperature.

In order to solve the above-mentioned problem, a nonaqueous electrolyte secondary battery according to the present invention includes a positive electrode; a negative electrode; a separator interposed between the positive electrode and the negative electrode; a nonaqueous electrolytic solution; an exterior body that houses the positive electrode, the negative electrode, the separator, and the nonaqueous electrolytic solution; a positive electrode terminal electrically connected to the positive electrode and extended outside the exterior body; and a negative electrode terminal electrically connected to the negative electrode and extended outside the exterior body. The nonaqueous electrolytic solution contains an imide salt of perfluoroalkane sulfonic acid. The negative electrode contains a noble negative electrode active material that has a lithium occlusion/release potential of 1.0 V (vs Li/Li⁺) or higher; and the battery voltage is 0 V to 1.0 V.

In addition, an electric storage device according to the present invention is an electric storage device with the above-described nonaqueous electrolyte secondary battery mounted on a substrate that includes a first electrode and a second electrode, and the positive electrode terminal is soldered to the first electrode, and the negative electrode terminal is soldered to the second electrode.

In addition, a method for manufacturing an electric storage device according to the present invention includes steps of soldering the positive electrode terminal of the nonaqueous electrolyte secondary battery to the first electrode of the substrate by a reflow-type soldering method; and soldering the negative electrode terminal of the nonaqueous electrolyte secondary battery to the second electrode of the substrate by a reflow-type soldering method.

In addition, an electricity storage circuit according to the present invention is characterized in that the above-described nonaqueous electrolyte secondary battery and an electric double layer capacitor are connected in parallel.

The nonaqueous electrolyte secondary battery according to the present invention makes it possible to, even in the case of exposure to high temperatures in excess of 200° C., provide a highly reliable lithium ion secondary battery without characteristic degradation.

Further, according to the present invention, it is also possible to reflow-mount, onto a substrate, the nonaqueous electrolyte secondary battery which is not charged/discharged (which has the electrolytic solution injected), and thereafter charge/discharge the battery, and it is also possible to, after initial charge/discharge, perform reflow mounting with the battery voltage reduced to equal to or lower than a certain level by discharging to lower than 0 V.

In addition, even in the case of exposure to high temperatures in excess of 200° C., there is no significant characteristic degradation, thus allowing surface mounting onto a substrate by reflow-type soldering at high temperature, for example.

Further, examples of the imide salt of perfluoroalkanesulfonic acid included in the nonaqueous electrolyte include, for example, LiTFSI (lithium bis(trifluoromethanesulfonyl)imide), LiFSI (lithium bis(fluorosulfonyl)imide, and LiBETI (lithium bis(pentafluoroethylsulfonyl)imide).

In addition, examples of the noble negative electrode active material with a lithium occlusion/release potential of 1.0 V (vs Li/Li⁺) or higher, which is used as a negative electrode active material in the nonaqueous electrolyte secondary battery according to the present invention, include, for example, LiNb₂O₅, LiNbO₃, and a lithium titanium oxide that has a spinel-type crystal structure. Further, examples of the lithium titanium oxide of spinel-type crystal structure, which is preferably used in the present invention, include, for example, Li₄Ti₅O₁₂.

In addition, the electric storage device according to the present invention makes it possible to provide a highly reliable electric storage device without characteristic degradation, even when the positive electrode terminal and the negative electrode terminal are joined to the first electrode and second electrode of the substrate by various soldering methods.

In addition, the method for manufacturing an electric storage device according to the present invention causes no characteristic degradation, even when the nonaqueous electrolyte secondary battery is mounted onto a substrate through the use of a reflow-type soldering method.

As a result, it becomes possible to mount the nonaqueous electrolyte secondary battery efficiently onto the substrate through the use of the reflow-type soldering method, and a highly reliable electric storage device with excellent heat resistance can be thus manufactured efficiently.

In addition, in the electricity storage circuit according to the present invention, when the nonaqueous electrolyte secondary battery and the electric double layer capacitor are connected in parallel, the configured electric storage circuit (that is, the electric storage device with the nonaqueous electrolyte secondary battery and the electric double layer capacitor connected in parallel) has dramatically improved reliability.

### BRIEF EXPLANATION OF THE DRAWINGS

FIG. 1 is a cross-sectional view illustrating the internal structure of a nonaqueous electrolyte secondary battery according to an embodiment (Embodiment 1) of the present invention,

FIG. 2 is a diagram showing a reflow profile in a reflow step in manufacturing a nonaqueous electrolyte secondary battery according to Embodiment 1 of the present invention.

FIG. 3 is a diagram showing the configuration of an electric storage circuit according to another embodiment (Embodiment 2) of the present invention.

### DETAILED DESCRIPTION OF THE INVENTION

### Embodiment 1

Before describing a nonaqueous electrolyte secondary battery according to the present invention in detail, a summary of the configuration of the nonaqueous electrolyte secondary battery according to the present invention will be described first.

The nonaqueous electrolyte secondary battery according to the present invention includes: a positive electrode; a negative electrode; a separator; a nonaqueous electrolytic solution; an exterior body that houses the electrodes, the separator, and the solution; a positive electrode terminal electrically connected to the positive electrode and extended outside the exterior body; and a negative electrode terminal electrically connected to the negative electrode and extended outside the exterior body.

Further, the positive electrode constituting the nonaqueous electrolyte secondary battery according to the present invention is formed, for example, by providing a positive electrode active material layer on a positive electrode current collector.

Specifically, for example, aluminum foil is used as the positive electrode current collector. Further, a combination layer containing a lithium composite oxide such as LiCoO₂, LiCo_{1/3}Ni_{1/3}Mn_{1/3}O₂, LiFePO₄, or LiMn₂O₄ is provided as the positive electrode active material layer on the aluminum foil as a positive electrode current collector. Thus, the positive electrode is formed.

Further, the negative electrode is formed, for example, by providing a negative electrode active material layer on a negative electrode current collector.

Specifically, for example, aluminum foil is used as the negative electrode current collector. Further, on the aluminum foil as the negative electrode current collector, a combination layer containing a noble substance that has a lithium occlusion/release potential of 1.0 V (vs Li/Li⁺) or more is provided as a negative electrode active material layer. Thus, the negative electrode is formed.

It is to be noted that it is preferable to use, as the negative electrode current collector, aluminum foil as described above. When copper foil is used as the negative electrode current collector, the copper will be dissolved and precipitated, and there is a possibility that the battery may be short-circuited due to the generation of dendrite.

As described above, the negative electrode contains the negative electrode active material (for example, Li₄Ti₅O₁₂ or the like) that has a lithium occlusion/release potential of 1.0 V (vs Li/Li⁺) or more, thereby stopping the active material and the aluminum foil from being alloyed with lithium during charge/discharge, and thus making it possible to use aluminum foil as the negative electrode current collector. As a result, even when the battery voltage is lowered, the negative electrode current collector is not dissolved or precipitated, and there is no possibility of short-circuiting the battery due to the generation of dendrite, thereby making it possible to make the battery voltage 0 V to 1.0 V.

Furthermore, the positive electrode (layer) and the negative electrode (layer) are opposed to each other with the separator (layer) interposed between the positive electrode and the negative electrode, thereby configuring the battery to reliably prevent short circuits due to contact between the electrodes.

As the separator, a heat-resistant material can be used which has, for example, a composition containing at least one selected from the group consisting of polyethylene terephthalate, cellulose, polyamide imide, polyimide, and an inorganic filler.

Further, when an attempt is made to mount the nonaqueous electrolyte secondary battery onto a substrate by reflow-type soldering (hereinafter also referred to simply as “reflow soldering”), the nonaqueous electrolyte secondary battery is exposed to high temperature. For example, when soldering is performed at a reflow temperature of 260° C. by a reflow soldering method as in the examples described later, the nonaqueous electrolyte secondary battery is heated to a high temperature in excess of 200° C., for example. Therefore, in order to make the nonaqueous electrolyte secondary battery surface-mountable onto the substrate by reflow soldering, it is necessary for the electrolyte constituting the nonaqueous electrolyte secondary battery to undergo no thermal decomposition reaction even at a temperature in excess of 200° C.

Now, among electrolytes for use in nonaqueous electrolyte secondary batteries, for example, LiPF₆ and LiBF₄ undergo thermal decomposition reaction at a relatively low temperature, but imide salts of perfluoroalkanesulfonic acids such as LiTFSI (lithium bis(trifluoromethanesulfonyl)imide), LiFSI (lithium bis(fluorosulfonyl)imide, and LiBETI (lithium bis(pentafluoroethylsulfonyl)imide) have features of having high thermal decomposition temperatures of 260° C. or higher and being less likely to undergo thermal decomposition.

In addition, when LiPF₆ or LiBF₄ is used as the electrolyte, for example, the anion of the electrolyte such as PF₆⁻ or BF₄⁻ is more likely react with PVDF or the like, for example, for use as a binder for the electrodes in the case of high temperature, but when an imide salt of perfluoroalkanesulfonic acid is used, such as LiTFSI, LiFSI, or LiBETI, TFSI⁻ or FSI⁻ as the anion of the electrolyte has the feature of being less likely to react with PVDF or the like for use as a binder in the case of high temperature.

Therefore, an electrolyte with a thermal decomposition temperature of 260° C. or higher, for example, 1 mol/l of an imide salt of perfluoroalkanesulfonic acid, such as LiTFSI, LiFSI, or LiBETI, dissolved in a solvent containing propylene carbonate or the like is used as the electrolytic solution, thereby making it possible for the nonaqueous electrolyte secondary battery to be surface-mounted on the substrate by reflow soldering at 260° C.

However, even in such a manufacturing method, when the battery voltage becomes equal to or higher than a predetermined level, it is actually not possible to surface-mount the nonaqueous electrolyte secondary battery onto the substrate by reflow soldering at 260° C. or higher, because an electrochemical reaction is also added. The reason is not known exactly, but believed to be because, even when an electrolytic solution with an imide salt of perfluoroalkanesulfonic acid such as LiTFSI, LiFSI, or LiBETI dissolved in an organic solvent is used as an electrolyte, the electrode or the like is damaged due to reactivity increased by a nucleophilic reagent reaction in the case of high temperature, and further the addition of an electrochemical reaction.

On the other hand, when an electrolytic solution with an imide salt of perfluoroalkanesulfonic acid such as LiTFSI, LiFSI, or LiBETI dissolved in an organic solvent is used as an electrolyte, and when a high temperature treatment (reflow at a high temperature in excess of 260° C.) is performed with the battery voltage reduced to equal to or lower than a certain level (that is, at the battery voltage adjusted to 1.0 V or higher, 0 V or lower) so as to keep from developing an electrochemical reaction and a thermal reaction in the case of high temperature, it becomes possible to surface-mount the nonaqueous electrolyte secondary battery onto the substrate without causing characteristic degradation.

Further, injecting the electrolytic solution, performing reflow at, for example, 260° C. without initial charge/discharge (with a battery voltage of 1.0 V or lower, 0 V or higher), thereby surface-mounting the nonaqueous electrolyte secondary battery onto the substrate, and then initially charging/discharging the nonaqueous electrolyte secondary battery make it possible to surface-mount the nonaqueous electrolyte secondary battery onto the substrate (that is, to obtain an electric storage device with the electrolyte secondary battery reflow-soldered) without causing characteristic degradation of the nonaqueous electrolyte secondary battery.

In addition, injecting an electrolytic solution, after initial charge/discharge, discharging under a condition such that the discharge cutoff voltage of the battery voltage is lower than 0 V, making shipment with the battery voltage reduced to equal to or lower than a certain level (1.0 V or lower, 0 V or higher), and thereafter, surface-mounting onto a substrate by, for example, a reflow soldering method at 260° C. also make it possible to surface-mount the nonaqueous electrolyte secondary battery onto the substrate at high temperature without causing deterioration of the nonaqueous electrolyte secondary battery.

Now, when copper foil is used as a negative electrode current collector, the copper will be dissolved and precipitated, and there is a possibility that the battery may be short-circuited due to the generation of dendrite, thus, it is not usual to reduce the battery voltage to equal to or lower than a certain level.

In addition, in the case of a mechanism that lithium ions are occluded/released between layers of d(002) plane, such as graphite, thermal decomposition is caused on reaching a high temperature of, for example, 260° C. or higher, such as during reflow.

On the other hand, according to the present invention, the use of, for the negative electrode, a negative electrode active material with a lithium occlusion/release potential of 1.0 V (Li/Li⁺) or higher makes it possible to reduce the battery voltage to equal to or lower than a certain level, thereby making it possible to supply reflow-compatible batteries capable of adapting shipping inspection (initial charge/discharge).

Examples of the electrolytic solution preferably for use in the nonaqueous electrolyte secondary battery according to the present invention include, for example, an electrolytic solution obtained by dissolving an electrolyte containing at least one of LiTFSI, LiFSI, LiBETI, in an organic solvent selected from dimethyl carbonate, diethyl carbonate, methylethyl carbonate, propylene carbonate, and γ-butyrolactone, which are generally used in lithium ion secondary batteries, or in a mixed organic solvent thereof. From the viewpoint of boiling point, it is preferable to use, in particular, propylene carbonate, γ-butyrolactone.

In addition, an electrolytic solution and the like can be also used which have the above-mentioned organic solvent or electrolyte salt dissolved in, as a solvent, an ionic liquid selected from 1-ethyl-3-methylimidazolium tetrafluoroborate and 1-ethyl-3 methylimidazolium bis(trifluoromethanesulfonyl)imide, or a mixed ionic liquid thereof.

Desirably, the charge cutoff voltage in the use of the nonaqueous electrolyte secondary battery according to the present invention is 2.70 V, preferably 2.60 V, more preferably 2.50 V, whereas the discharge cutoff voltage is 1.25 V, preferably 1.50 V, more preferably 1.80 V.

Furthermore, the nonaqueous electrolyte secondary battery according to the present invention is connected in parallel with an electric double layer capacitor, thereby making it possible to obtain an electricity storage circuit (electric storage device) which combines both a large-current characteristic and a large capacity, and has high reliability.

Conventionally, it has been known that a nonaqueous electrolyte secondary battery and an electric double layer are connected in parallel, thereby combining both a larger-current characteristic and a larger capacity. Electric double layer capacitors have a feature of extremely little performance degradation since only simple physical phenomena take place. On the other hand, nonaqueous electrolyte secondary batteries have a substance changed by electrochemical reaction, unlike electric double layer capacitors, and are known to be more likely to cause performance degradation as compared with electric double layer capacitors.

Therefore, when a common nonaqueous electrolyte secondary battery and an electric double layer capacitor are connected in parallel, the performance of the parallel-connected circuit also undergoes performance degradation depending on the performance degradation of the nonaqueous electrolyte secondary battery.

On the other hand, the nonaqueous electrolyte secondary battery according to the present invention undergoes little performance degradation, and thus, when the nonaqueous electrolyte secondary battery according to the present invention and an electric double layer capacitor are connected in parallel, the parallel-connected circuit also has reliability dramatically increased.

In addition, the nonaqueous electrolyte secondary battery according to the present invention is close in operating voltage range to electric double layer capacitors that use common organic solvents, thus, the control circuit can be simplified, it is not necessary to consider the prevention of current backflow, etc., and the number of parts can be greatly reduced.

### EXAMPLES

Hereinafter, the present invention will be described in more detail with reference to examples of the present invention.

It is to be noted that for the foregoing examples, prepared were: nonaqueous electrolyte secondary batteries that satisfy the requirements of the present invention according to Examples 1 to 13 in Table 1A; and nonaqueous electrolyte secondary batteries that fail to satisfy the requirements of the present invention according to Comparative Examples 1 to 11 in Table 1B.

### Preparation of Positive Electrode

A lithium-cobalt composite oxide (LCO) represented by a composition formula LiCoO₂ as a positive electrode active material, carbon as a conductive agent, and polyvinylidene fluoride (PVDF) as a binder were combined for 90:7:3 in ratio by weight, and kneaded with N-methyl 2-pyrrolidone (NMP) to prepare a slurry. This slurry was applied to both sides of an aluminum foil as a current collector such that the weight of the positive electrode combination on one side was 8.11 mg/cm², dried, then adjusted in thickness with a roll press such that the packing density of the positive electrode layer was 3.3 g/cm³, and cut into a width of 8.5 mm and a length of 23.0 mm, thereby preparing a positive electrode.

### Preparation of Negative Electrode

A spinel-type lithium-titanium composite oxide represented by Li₄Ti₅O₁₂ as a negative electrode active material and PVDF as a binder were combined for 95:5 in ratio by weight, and kneaded with NMP to prepare a slurry. This slurry was applied to both surfaces of an aluminum foil as a current collector such that the weight of negative electrode combination on one side was 5.30 mg/cm², dried, and then adjusted in thickness wish a roll press such that the packing density of the negative electrode layer was 2.0 g/cm³, and cut into a width of 8.5 mm and a length of 34.0 mm, thereby preparing a negative electrode.

### Preparation of Nonaqueous Electrolytic Solution

For sample Nos. 1, 3, 5, 6, 9, and 10 according to the examples of the present invention and sample Nos. 10 and 11 as the comparative examples, nonaqueous electrolytic solutions were prepared by dissolving 1 mol/l LiTFSI in a mixed solvent of propylene carbonate.

For Examples 2, 4, 7, 8, 11, and 12, nonaqueous electrolytic solutions were prepared by dissolving 1 mol/l LiFSI in a mixed solvent of propylene carbonate.

For Example 13, a nonaqueous electrolytic solution was prepared by dissolving 1 mol/l LiBETI in a mixed solvent of propylene carbonate.

For Comparative Examples 1, 3, 4, 5, 6 and 7, nonaqueous electrolytic solutions were prepared by dissolving 1 mol/l of LiPF₆ in a mixed solvent of propylene carbonate.

For Comparative Examples 2, 8, and 9, nonaqueous electrolytic solutions were prepared by dissolving 1 mol/l LiBF₄ in a mixed solvent of propylene carbonate.

For the nonaqueous electrolyte secondary batteries according to Examples 1, 2, 5, 6, 7, 8 and 13 in Table 1A and the nonaqueous electrolyte secondary batteries according to Comparative Examples 1, 3, 4, 5, 6, 7, 8, 9, 10, and 11, aramid-containing separators were used.

In addition, for the nonaqueous electrolyte secondary batteries according to Examples 3, 4, 9, 10, 11, and 12 and the nonaqueous electrolyte secondary battery according to Comparative Example 2, a cellulose-containing separator was used.

### Preparation of Nonaqueous Electrolyte Secondary Battery

FIG. 1 is a cross-sectional view illustrating the internal structure of a nonaqueous electrolyte secondary battery according to an example of the present invention.

As shown in FIG. 1, the nonaqueous electrolyte secondary battery 10 includes: a battery element 1 including a positive electrode, a negative electrode, and a separator interposed between the positive electrode and the negative electrode; an exterior body (case) 2 made of aluminum, for housing the battery element 1 and a nonaqueous electrolytic solution; a sealing material 3 for sealing the opening of the exterior body 2; aluminum leads 4 provided on the positive electrode and the negative electrode; and lead wires 5 connected to the aluminum leads 4. It is to be noted that, Sn-plated copper wires containing Bi are used for the lead wires 5.

Next, a method for manufacturing the nonaqueous electrolyte secondary battery 10 will be described. In manufacturing the nonaqueous electrolyte secondary battery 10, first, the aluminum leads 4 with the lead wires 5 connected thereto were provided on the positive electrode and the negative electrode prepared as described above.

Then, the separator (for example, air permeability; 10 sec. 100 cc) for each of the respective examples shown in Table 1A and the respective comparative examples shown in Table 1B was interposed and wound between the positive electrode and the negative electrode, thereby preparing the battery element 1.

Next, this battery element 1 was impregnated with an electrolytic solution for each of the respective examples shown in Table 1A and the respective comparative examples shown in Table 1B.

Thereafter, the battery element 1 is provided with the sealing material 3 made of an isobutylene-isoprene rubber, and inserted into the exterior body (case) 2 made of aluminum, and the opening of the exterior body 2 is caulked, thereby sealing the opening of the exterior body 2. In this way, a nonaqueous electrolyte secondary battery (samples according to Examples 1 to 13 in Table 1A and samples according to Comparative Examples 1 to 11 in Table 1B) 10 as shown in FIG. 1 was prepared.

### Initial Charge/Discharge Process and Measurement of Capacity for Nonaqueous Electrolyte Secondary Battery

The nonaqueous electrolyte secondary batteries according to Examples 1 to 4 and the nonaqueous electrolyte secondary batteries according to Comparative Examples 1 and 2 were not initially charge/discharged as shown in Tables 1A and 1B. Therefore, the columns of discharge current and the columns of retention time at discharge cutoff voltage are also blank in Table 1A and Table 1B. It is to be noted that the open circuit voltages (battery voltages) of the nonaqueous electrolyte secondary batteries according to Examples 1 to 4 and the nonaqueous electrolyte secondary batteries according to Comparative Examples 1 and 2 are as shown in Table 1A and Table 1B.

Then, for the nonaqueous electrolyte secondary batteries according to Examples 1 to 4 and the nonaqueous electrolyte secondary batteries according to Comparative Examples 1 and 2, which were not initially charged/discharged as described above, the discharge capacity (discharge capacity before reflow) in the condition (the condition before reflow mounting) was calculated from the positive electrode and negative electrode constituting each nonaqueous electrolyte secondary battery, the active materials used for the electrodes, the type of the electrolyte, and the like.

In addition, the respective nonaqueous electrolyte secondary batteries according to Examples 5 to 13 and Comparative Examples 3 to 11 were initially charged, and thereafter, discharged under the conditions (discharge current and discharge cutoff voltage) shown in Table 1A and Table 1B.

Then, after constant-current charge was performed with a current adjusted to 2.0 mA under an atmosphere at a temperature of 25° C., and constant-voltage charge was performed with a voltage adjusted to 2.70 V until the charge current reached 0.10 mA. Thereafter, constant-current discharge was performed with a current adjusted to 2.0 mA until the voltage reached 1.80 V, and the discharge capacity (discharge capacity before reflow) was measured.

Thereafter, the respective batteries according to Examples 5 to 13 and Comparative Examples 3 to 11 were discharged so as to achieve the respective open circuit voltages (battery voltages).

### Reflow Mounting (Mounting onto Substrate)

The nonaqueous electrolyte secondary batteries according to Examples 1 to 13 in Table 1A and the nonaqueous electrolyte secondary batteries according to Comparative Examples 1 to 11 in Table 1B as prepared in the way described above were surface-mounted onto a substrate by the method described below.

First, as the substrate, a substrate provided with a first electrode and a second electrode was prepared.

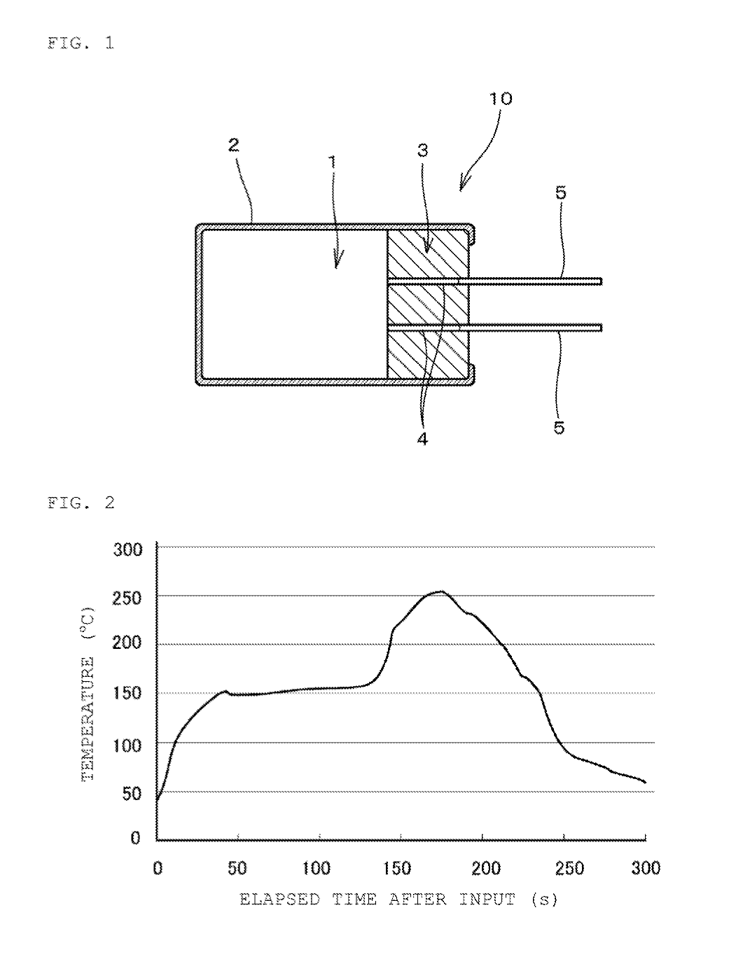

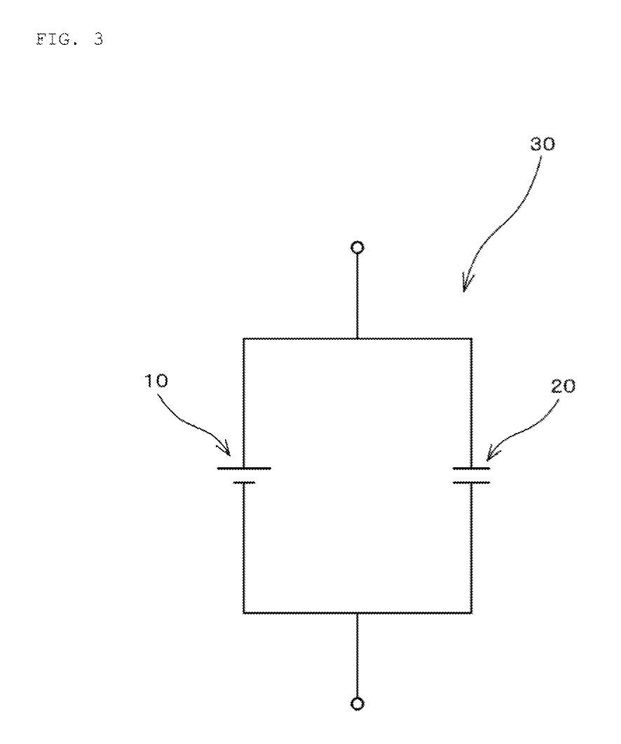

Then, the respective nonaqueous electrolyte secondary batteries according to the examples in Table 1A and the respective nonaqueous electrolyte secondary batteries according to comparative examples in Table 1B were passed through a reflow furnace in accordance with the reflow profile shown in FIG. 2 to solder positive and negative electrode terminals of the nonaqueous electrolyte secondary battery respectively to the first electrode of the substrate and the second electrode of the substrate, thereby surface-mounting each nonaqueous electrolyte secondary battery surface onto the substrate.

### Measurement of Discharge Capacity after Reflow and Capacity Retention Rate after Reflow

Then, for each of the nonaqueous electrolyte secondary batteries surface-mounted on the substrate by the passage through the reflow furnace, each battery was subjected to constant-current charge with a current adjusted to 2.0 mA under an atmosphere at a temperature of 25° C., and then to constant-voltage charge with a voltage adjusted to 2.70 V, until the charge current reached 0.10 mA.

Subsequently, each nonaqueous electrolyte secondary battery was subjected to constant-current discharge with a current adjusted to 2.0 mA until the voltage reached 1.80 V, and then soldered by passage through a reflow furnace, thereby surface-mounting the battery onto the substrate, and the discharge capacity (discharge capacity after reflow) was then measured.

Then, the ratio (capacity retention rate after reflow) of the discharge capacity (discharge capacity after reflow) after soldering by the passage through the reflow furnace to the discharge capacity (discharge capacity before reflow) before the soldering by the passage through the reflow furnace was obtained from the following formula (1), and characteristics were evaluated for each nonaqueous electrolyte secondary battery.

Capacity Retention Rate after Reflow=(Discharge Capacity after Reflow/Discharge Capacity before Reflow)×100 (1)

It is to be noted that for the nonaqueous electrolyte secondary batteries according to Examples 1 to 4 and the nonaqueous electrolyte secondary batteries according to Comparative Examples 1 and 2, the capacity retention rate after reflow was calculated in accordance with the above formula (1) from the discharge capacity before reflow, calculated as described above, and the actually measured discharge capacity after reflow.

The results are shown in Table 1A and Table 1B.

TABLE 1A

| | | | | | | | Open Circuit | |
|---|---|---|---|---|---|---|---|---|
| | | | | | | Retention Time | Voltage | Capacity |
| | | | Initial | | Discharge | at Discharge | (Battery | Retention Rate |
| | | | Charge/ | Discharge | Cutoff | Cutoff Voltage | Voltage) | after Reflow |
| | Electrolyte | Separator | Discharge | Current | Voltage | (h) | (V) | (%) |
| Example 1 | LiTFSI | Aramid | not performed | — | — | — | 0.243 | 100 |
| Example 2 | LiFSI | Aramid | not performed | — | — | — | 0.242 | 100 |
| Example 3 | LiTFSI | Cellulose | not performed | — | — | — | 0.224 | 100 |
| Example 4 | LiFSI | Cellulose | not performed | — | — | — | 0.235 | 100 |
| Example 5 | LiTFSI | Aramid | performed | 1c | −1.0 V | 4 | 0.636 | 50 |
| Example 6 | LiTFSI | Aramid | performed | 1c | −2.0 V | 4 | 0.595 | 52 |
| Example 7 | LiFSI | Aramid | performed | 1c | −1.0 V | 4 | 0.612 | 51 |
| Example 8 | LiFSI | Aramid | performed | 1c | −2.0 V | 4 | 0.585 | 53 |
| Example 9 | LiTFSI | Cellulose | performed | 1c | −1.0 V | 4 | 0.632 | 50 |
| Example 10 | LiTFSI | Cellulose | performed | 1c | −2.0 V | 4 | 0.584 | 52 |
| Example 11 | LiFSI | Cellulose | performed | 1c | −1.0 V | 4 | 0.608 | 51 |
| Example 12 | LiFSI | Cellulose | performed | 1c | −2.0 V | 4 | 0.587 | 53 |
| Example 13 | LiBETI | Aramid | performed | 1c | −1.0 V | 4 | 0.834 | 52 |

TABLE 1B

| | | | | | | | Open Circuit | |
|---|---|---|---|---|---|---|---|---|
| | | | | | | Retention Time | Voltage | Capacity |
| | | | Initial | | Discharge | at Discharge | (Battery | Retention Rate |
| | | | Charge/ | Discharge | Cutoff | Cutoff Voltage | Voltage) | after Reflow |
| | Electrolyte | Separator | Discharge | Current | Voltage | (h) | (V) | (%) |
| Comparative | | | | | | | | |
| Example 1 | LiPF₆ | Aramid | not performed | — | — | — | 0.225 | 0 |
| Comparative | | | | | | | | |
| Example 2 | LiBF₄ | Cellulose | not performed | — | — | — | 0.262 | 0 |
| Comparative | | | | | | | | |
| Example 3 | LiPF₆ | Aramid | performed | 1c | −1.0 V | 4 | 0.572 | 0 |
| Comparative | | | | | | | | |
| Example 4 | LiPF₆ | Aramid | performed | 1c | −1.0 V | 4 | 0.631 | 0 |
| Comparative | | | | | | | | |
| Example 5 | LiPF₆ | Aramid | performed | 1c | −1.0 V | 4 | 0.599 | 0 |
| Comparative | | | | | | | | |
| Example 6 | LiPF₆ | Aramid | performed | 1c | −1.0 V | 4 | 0.611 | 0 |
| Comparative | | | | | | | | |
| Example 7 | LiPF₆ | Aramid | performed | 1c | −1.0 V | 4 | 0.523 | 0 |
| Comparative | | | | | | | | |
| Example 8 | LiBF₄ | Aramid | performed | 1c | −1.0 V | 4 | 0.578 | 0 |
| Comparative | | | | | | | | |
| Example 9 | LiBF₄ | Aramid | performed | 1c | −1.0 V | 4 | 0.512 | 0 |
| Comparative | | | | | | | | |
| Example 10 | LiTFSI | Aramid | performed | 1c | −1.5 V | 0.5 | 1.823 | 0 |
| Comparative | | | | | | | | |
| Example 11 | LiTFSI | Aramid | performed | 1c | 0 V | 5 | 1.012 | 0 |

As shown in Table 1A, it has been confirmed that the nonaqueous electrolyte secondary batteries according to Examples 1 to 13, which meet: the requirement that the battery voltage (open circuit voltage) is 1.0 V or lower, 0 V or higher; the requirement that the nonaqueous electrolytic solution contains an imide salt of perfluoroalkanesulfonic acid (LiTFSI, LiFSI, LiBETI); and the requirement that the negative electrode includes a noble negative electrode active material with a lithium occlusion/release potential of 1.0 V (vs Li/Li⁺) or higher, have favorable capacity retention rates (capacity retention rate after reflow) even when the batteries are mounted onto the substrate through the reflow process.

On the other hand, it has been confirmed that all of:

(a) the nonaqueous electrolyte secondary batteries according to Comparative Examples 1 to 9 using, as an electrolyte, LiPF₆ and LiBF₄ which undergo thermal decomposition at relatively low temperature;

(b) the nonaqueous electrolyte secondary battery according to Comparative Example 10, with the open circuit voltage (battery voltage) of 1.823 V, which fails to satisfy the requirement of 1.0 V or lower as a requirement of the present invention; and

(c) the nonaqueous electrolyte secondary battery according to Comparative Example 11, with the open circuit voltage (battery voltage) of 1.012 V, which fails to satisfy the requirement of 1.0 V or lower as a requirement of the present invention,

which are all 0% in capacity retention rate after reflow, are significantly damaged in the reflow process, thereby impairing the functions as nonaqueous electrolyte secondary batteries.

### Embodiment 2

In Embodiment 2 herein, the configuration of an electric storage circuit that uses the nonaqueous electrolyte secondary battery according to the present invention will be described.

As shown in FIG. 3, the electric storage circuit 30 according to Embodiment 2 herein is formed by connecting the nonaqueous electrolyte secondary battery 10 according to the embodiment of the present invention and an electric double layer capacitor 20 in parallel.

As the nonaqueous electrolyte secondary battery 10, a nonaqueous electrolyte secondary battery is used that meets the requirements of the present invention as prepared above in Embodiment 1.

Further, as the electric double layer capacitor 20, an electric double layer capacitor can be used which has a structure in accordance with, for example, a structure where an electrode provided with a combination layer including a carbon material (for example, activated carbon) as a positive electrode active material layer on an aluminum foil as a positive electrode current collector layer is adopted as a positive electrode, an electrode provided with a combination layer including a carbon material (for example, activated carbon) as a negative electrode active material layer on an aluminum foil as a negative electrode current collector layer is adopted as a negative electrode, and a stacked body with the positive electrode and the negative electrode stacked with a separator interposed therebetween is housed in an outer covering material along with an electrolytic solution with 1 mol/l triethylmethylammonium tetrafluoroborate dissolved in propylene carbonate, that is, for example, the structure of the nonaqueous electrolyte battery 10 in FIG. 1.

It is to be noted that there is no particular restriction on the configuration of the electric double layer capacitor, and it is possible to make an appropriate selection for use from known capacitors configured variously.

It is to be noted that in the electric storage circuit 30 according to the present invention, it is also possible to provide a control circuit such as a bypass circuit for bypassing electric current so as to keep from charging any more when the electric double layer capacitor 20 reaches a predetermined charge voltage.

In the electric storage circuit 30 configured as described above, the nonaqueous electrolyte secondary battery according to the present invention is used as the nonaqueous electrolyte secondary battery 10, and as described above in Embodiment 1, the nonaqueous electrolyte secondary battery 10 undergoes little performance degradation, and thus, the electric storage circuit 30 with the nonaqueous electrolyte secondary battery 10 and the electric double layer capacitor 20 connected in parallel also has reliability improved dramatically.

It is to be noted that the present invention is not to be considered limited to the embodiments described above, but various applications and modifications can be made within the scope of the invention, in regard to the constituent materials of the positive electrode and negative electrode constituting the nonaqueous electrolyte secondary battery, and the methods for forming the positive and negative electrodes, the material constituting the separator, and the like.

### DESCRIPTION OF REFERENCE SYMBOLS

1: battery element
2: exterior body (case)
3: sealing material
4: aluminum lead
5: lead wire
10: nonaqueous electrolyte secondary battery
20: electric double layer capacitor
30: electric storage circuit

1. A nonaqueous electrolyte secondary battery comprising:
a positive electrode;
a negative electrode, the negative electrode containing a noble negative electrode active material that has a lithium occlusion/release potential of 1.0 V (vs Li/Li⁺) or higher;
a separator interposed between the positive electrode and the negative electrode;
a nonaqueous electrolytic solution containing an imide salt of perfluoroalkanesulfonic acid;
an exterior body that houses the positive electrode, the negative electrode, the separator, and the nonaqueous electrolytic solution;
a positive electrode terminal electrically connected to the positive electrode and extended outside the exterior body; and
a negative electrode terminal electrically connected to the negative electrode and extended outside the exterior body,
wherein a battery voltage of the nonaqueous electrolyte secondary battery is 0 V to 1.0 V.

2. The nonaqueous electrolyte secondary battery according to claim 1, wherein the negative electrode includes the negative electrode active material layer on a negative electrode current collector.

3. The nonaqueous electrolyte secondary battery according to claim 2, wherein the negative electrode current collector is aluminum foil.

4. The nonaqueous electrolyte secondary battery according to claim 3, wherein the positive electrode includes a positive electrode active material layer on a positive electrode current collector.

5. The nonaqueous electrolyte secondary battery according to claim 4, wherein the positive electrode current collector is aluminum foil and the positive electrode active material layer contains a lithium composite.

6. The nonaqueous electrolyte secondary battery according to claim 5, wherein the lithium composite is selected from LiCoO₂, LiCo_{1/3}Ni_{1/3}Mn_{1/3}O₂, LiFePO₄, and LiMn₂O₄.

7. The nonaqueous electrolyte secondary battery according to claim 1, wherein the positive electrode includes a positive electrode active material layer on a positive electrode current collector.

8. The nonaqueous electrolyte secondary battery according to claim 7, wherein the positive electrode current collector is aluminum foil and the positive electrode active material layer contains a lithium composite.

9. The nonaqueous electrolyte secondary battery according to claim 8, wherein the lithium composite is selected from LiCoO₂, LiCo_{1/3}Ni_{1/3}Mn_{1/3}O₂, LiFePO₄, and LiMn₂O₄.

10. The nonaqueous electrolyte secondary battery according to claim 1, wherein a material of the separator is a composition containing at least one selected from polyethylene terephthalate, cellulose, polyamide imide, polyimide, and an inorganic filler.

11. The nonaqueous electrolyte secondary battery according to claim 1, wherein the imide salt of perfluoroalkanesulfonic acid is at least one of lithium bis(trifluoromethanesulfonyl)imide, lithium bis(fluorosulfonyl)imide, and lithium bis(pentafluoroethylsulfonyl)imide.

12. The nonaqueous electrolyte secondary battery according to claim 1, wherein the imide salt of perfluoroalkanesulfonic acid has a thermal decomposition temperature of 260° C. or higher.

13. The nonaqueous electrolyte secondary battery according to claim 1, wherein the noble negative electrode active material is selected from LiNb₂O₅, LiNbO₃, and a lithium titanium oxide that has a spinel-type crystal structure.

14. The nonaqueous electrolyte secondary battery according to claim 13, wherein the noble negative electrode active material is the lithium titanium oxide that has the spinel-type crystal structure, and the lithium titanium oxide having the spinel-type crystal structure is Li₄Ti₅O₁₂.

15. An electric storage device comprising:
a substrate having a first electrode and a second electrode; and
the nonaqueous electrolyte secondary battery according to claim 1 mounted on the substrate such that the positive electrode terminal is soldered to the first electrode and the negative electrode terminal is soldered to the second electrode.

16. A method for manufacturing an electric storage device, the method comprising:
providing a nonaqueous electrolyte secondary battery that includes a positive electrode; a negative electrode, the negative electrode containing a noble negative electrode active material that has a lithium occlusion/release potential of 1.0 V (vs Li/Li⁺) or higher; a separator interposed between the positive electrode and the negative electrode; a nonaqueous electrolytic solution containing an imide salt of perfluoroalkanesulfonic acid; an exterior body that houses the positive electrode, the negative electrode, the separator, and the nonaqueous electrolytic solution; a positive electrode terminal electrically connected to the positive electrode and extended outside the exterior body; and a negative electrode terminal electrically connected to the negative electrode and extended outside the exterior body, wherein a battery voltage of the nonaqueous electrolyte secondary battery is 0 V to 1.0 V;
soldering the positive electrode terminal of the nonaqueous electrolyte secondary battery to a first electrode of a substrate by a reflow-type soldering method; and
soldering the negative electrode terminal of the nonaqueous electrolyte secondary battery to a second electrode of the substrate by a reflow-type soldering method.

17. An electric storage circuit comprising:
the nonaqueous electrolyte secondary battery according to claim 1; and
an electric double layer capacitor connected in parallel to the nonaqueous electrolyte secondary battery.

18. The electric storage circuit according to claim 17, wherein the negative electrode includes the negative electrode active material layer on a negative electrode current collector.

19. The electric storage circuit according to claim 18, wherein the negative electrode current collector is aluminum foil.

20. The electric storage circuit according to claim 17, wherein the imide salt of perfluoroalkanesulfonic acid is at least one of lithium bis(trifluoromethanesulfonyl)imide, lithium bis(fluorosulfonyl)imide, and lithium bis(pentafluoroethylsulfonyl)imide.
